(19) United States
(12) Patent Application Publication
(10) Pub. No.: US 2003/0159717 A1
(43) Pub. Date: Aug. 28, 2003

(54) Counter current washing

(75) Inventors: Gareth Evans, Hertfordshire (GB); Leslie R. Wells, Bounds Green (GB); Peter Hewitson, Uxbridge (GB); John R. Fyson, Hackney (GB)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/373,268

(22) Filed: Feb. 24, 2003

(30) Foreign Application Priority Data
Feb. 27, 2002 (GB) 0204528.4

(51) Int. Cl. B08B 3/00

(52) U.S. Cl. 134/26; 134/64 P; 134/95.1; 134/186; 134/60; 396/564

(57) ABSTRACT

A method of washing a process station and/or the material being processed therein uses a series of tanks of wash solution used in a sequential fashion. A first volume of wash solution is used and discarded to waste. Subsequent volumes of solution are transferred after use to the tank from which the previous volume of solution was supplied. The last volume of solution used is taken from a source of clean solution.

### CROSS REFERENCE TO RELATED APPLICATIONS

This is a U.S. original patent application which claims priority on Great Britain patent application No. 0204528.4 filed Feb. 27, 2002.

### FIELD OF THE INVENTION

This invention relates to photographic processing of color film and paper and in particular to the washing or stabilization stage. It relates particularly to processes which use “Single-Use” process systems. Single use process systems involve chemical treatment stages which use very low volumes of processing solutions and after the chemical process stages the equipment and processed material needs to be washed.

### BACKGROUND OF THE INVENTION

Commercial processing of photographic materials usually involves treatment of the materials with solutions containing chemicals by passing the materials through tanks containing the solutions. These solutions are modified by use in processing the materials and by exposure to the atmosphere. This results in chemical losses caused by oxygen and carbon dioxide and by evaporation. For consistent, high quality processing performance the solutions need to be actively maintained by replenishment and adjustment which takes into account these modifications. Replenishment provides replacement of chemicals, such as developing agent, and also results in the removal of substances which are introduced to the processing solutions during processing, such as halide ions. Maintenance of a constant chemical constitution of the solution involves the adjustment of replenishment rates according to measured solution performance or analysis. Such maintenance is time-consuming and costly. If it is not performed rigorously and regularly inferior and variable photographic performance results. It is particularly difficult to maintain replenished systems at a constant level of performance if they are not used often. There is a need to provide processing systems which are inexpensive to buy and to own and therefore do not require high levels of utilization in order to be commercially viable. This allows processing of films and production of prints from films and digital image files to be widely available and conveniently located.

An alternative approach is to use a so-called “Single-Use” process. In this case, the residence time of the solution in the process is approximately the same as the time taken for that part of the process cycle in which the solution is used. In the case of a developer, for example, the residence time is the same as the development time. A typical single use process might use an aliquot of solution to process a fixed area of material and after the end of the process step the solution is discarded. Fresh solution is then used for subsequent processing. The use of fresh solution ensures that the solution composition is known and results can be more consistent. This is especially valuable when processes are used intermittently.

Single use processors are known, for example, the Kodak H11 drum processor. Paper is held against the surface of a rotating drum with the emulsion side facing inwards. The lower part of the drum is immersed in a shallow trough containing processing solutions. The drum surface picks up liquid from the trough and the paper floats on the film of liquid. The solution is discarded after use but the volumes of liquid used are far too high for a viable, low-cost print production system and produce unacceptably large volumes of waste effluent which requires disposal or treatment.

Another example of a single-use process is a film spiral processor in which a film is fed onto a spiral mounting device which is inserted into a cylindrical tank. A lid is provided to provide a light-tight seal while allowing the addition and removal of solutions. Internal drum processors are also known in which photographic paper is introduced into a cylindrical tank with the emulsion side facing inwards. Liquid is introduced for processing and removed and discarded after use. Again, the volumes of liquid involved are undesirably high and the tanks have to be washed before re-use. The washing process may be combined with the washing of the processed material. A typical example of such apparatus is the Jobo ATL 2000 processor.

Single use systems using lower amounts of solution in relation to the area of material which is processed are known. For example an internal drum system is described in U.S. Pat. No. 6,505,979 in which the small volume of the solution used is held in the bottom of the rotating internal drum by a free-running roller. After development solutions are added to stop development, bleach the developed silver and remove silver halide.

In any of the above systems there is a need to remove substances from the processed material to ensure image stability. In deep-tank replenished systems material passes from one tank to the next. For example, with a color paper material, the material passes from a first development tank into a second and subsequent tanks, of fixer solution, etc.. It is usual for the paper to then pass into a series of wash tanks. These are usually inter-connected so that clean washing solution is added to the last of the tank series and over-flow from the last tank is transferred to the next tank and so on. In this way the flow of solution is in a direction which is counter to the direction of transport of the paper. This so-called counter-current flow technique enables efficient washing since when the material has the highest content of substances to be removed, the wash solution also has the highest concentration of removed substances and clean solution is only used in the last step when the processed material contains little removable contaminants. The table below is derived from a mathematical model which predicts the fraction of material remaining in color paper after a four tank counter-current wash stage in which 194 ml per square meter of solution is added to the last tank. High agitation is assumed which allows equilibrium between substances in the solution and processed material to be rapidly established.

| Counter-Current | Multiple Wash | |
|---|---|---|
| Number of tanks | 4 | 4 |
| Fraction of material left | 0.00067 | 0.00062 |
| Total Volume (ml per sq. ft.) | 194 | 818 |
| Total time @ 10 sec per tank | 40 | 40 |

Single use processing systems can either use the same process station for more than one process step or can use a sequence of processing stations for different steps. If a single station is used for more than one step the processed material occupies the station for longer and the productivity of the equipment is reduced. If a series of stations are used, each performing one step, productivity is highest but so is the size and cost of the equipment. A system using the same station for all process steps has the lowest productivity but also the lowest cost and size. Intermediate positions can be chosen. It is, for example, possible to pass the processed material from the single or last station in which the chemical process is performed into a counter-current wash stage. This allows the washing to be performed with minimal solution usage. However, in this case, any station used for an earlier process step, for example, the development step, is left empty after the material is removed but is contaminated with process solutions. Deep tanks can be left for long periods with only minor degradation of the solutions which, although needing to be taken into account by replenishment and maintenance routines, do not demand immediate attention. On the other hand a used single use development station would need cleaning to avoid the consequences of developer solution components being left on the surfaces of the equipment at elevated temperatures with no protection from the oxygen in the atmosphere.

In all the configurations of single use processing systems, whether single or multiple station or whether the processed material is washed using a counter-current system or not, cleaning the equipment either after material has been removed or simultaneously with the processed material is needed. This has to be performed by repeated use of small volumes of solution in order to reduce the amount of cleaning solution used. If however, several aliquots of unused cleaning solution are used, the amounts of solution needed and the time taken are both undesirably high. The table above shows the total volume used at the same number of operations and time taken as the counter-current case. Approximately four times as much solution is needed in this case. Although this ratio will depend on a number of factors such as the rates of replenishment and number of wash steps performed, the volumes used in wash sequences not using counter-current flow are always much higher.

The present invention aims to provide a processing system using at least one single-use process step in which processed material is washed to required standards of image permanence and in which the equipment used for the development and/or the silver removal steps is cleaned when the equipment is to be left unused.

### SUMMARY OF THE INVENTION

According to the present invention there is provided a method of washing a processing station and/or processed material located therein wherein wash solution is stored in and supplied from at least two tanks, one tank of which is supplied with a source of clean wash solution, the method comprising the steps of supplying a first volume of wash solution to the station and, after use, discarding said solution to waste, supplying at least a second volume of wash solution to the station and, after use, transferring said solution to the tank from which the previous volume of wash solution was supplied, the last volume of wash solution used being taken from the tank supplied with the source of clean wash solution.

The invention further provides an arrangement for washing a processing station and/or processed material located therein, comprising at least two supply tanks in which wash solution is stored and supplied from, one tank being in fluid connection with a supply of clean wash solution, the at least two tanks being connected to the processing station such that volumes of solution within each tank are used in sequence, each volume of solution passing from one tank to the processing station and then, after use, transferred to the tank from which the previous volume of solution was supplied, the tank in connection with the supply of clean wash solution being the last to supply a volume of wash solution to the station.

The washing of both processed material and equipment is performed using volumes of wash solution which are typical of counter-current wash systems rather than the volumes which are needed if the equipment were to be washed by a series of wash steps using fresh wash solution for each step. Thus the invention provides the advantages of economy of solution usage enabled by counter-current wash stabilizer systems and also provides the advantages of single-use processing, in particular reliable performance in intermittent and infrequent use. In addition, in cases in which a single station is used for several wash steps and particularly the wash steps are carried out in stations used for other process steps, the invention enables efficient washing without a series of wash tanks. This enables equipment costs to be reduced. It can be appreciated further that a wash system using a counter-current, multiple bath unit would need to be large enough to accommodate the size, particularly the width, of material processed. The wash tanks would need, for example, to be wide enough to enable a 20 cm web or sheet of material to be transported through the tank. The present invention provides the means to employ counter-current techniques in a way which is independent of the size of the processed material and can be physically small and of very low volume compared with a tank through which material is passed.

It is a further advantage of the small volumes possible, which could be typically just sufficient volume needed to perform a wash step, that the lifetime of the solution in the supply tanks is minimized. The lifetime is controlled by the ratio of the tank volume to the solution usage rates and can be therefore typically a few minutes while the equipment is in operation. This compares with several hours for a typical deep-tank counter-current flow system. As a result of these long residence times, bio-growth often occurs and measures have to be taken to overcome the effects of this problem. Growth limiters need to be supplied and disinfecting and cleaning routines employed. This can be avoided in the present invention.

Another advantage of using small tanks is that, when the tank volume is minimized, i.e. when the volume approximates to the volume to be transferred to the processor for washing, the tank can be used as the metering means. The pump, when it draws liquid from a tank can continue to pump until air is drawn into the connecting channels. After washing, the pump is reversed and again, it can run beyond the point when no more liquid flows. This purges the majority of the liquid from the commonly used channels, thus minimizing contamination of the cleaner liquid.

### BRIEF DESCRIPTION OF THE DRAWINGS

The invention will now be described, by way of example, with reference to the accompanying drawings, in which:

FIG. 1 is a schematic illustration of an arrangement according to the present invention;

FIG. 2 is a perspective view of an embodiment of the invention;

FIG. 3 is a schematic side view of part of FIG. 2;

FIG. 4 is a partial plan view of FIG. 3;

FIG. 5 is a schematic view of an embodiment of a top up arrangement for the invention;

FIG. 6 illustrates an alternative tank that may be used in the invention;

FIG. 7 is a further schematic illustration of an embodiment of the invention employing the tanks illustrated in FIG. 6; and

FIG. 8 illustrates a further alternative tank arrangement for use in the invention.

### DETAILED DESCRIPTION OF THE INVENTION

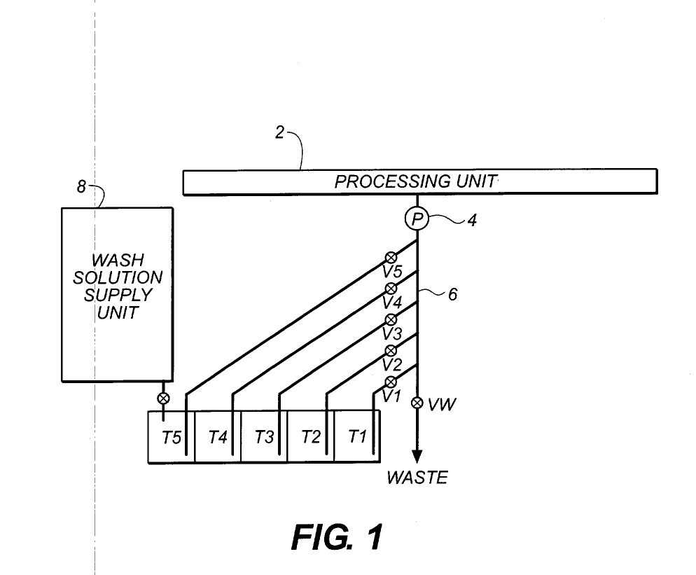

FIG. 1 is a schematic illustration of the invention.

A processing unit or station 2 and a wash solution supply unit 8 are connected via a number of tanks. The tanks are connected such that the solutions contained therein are used in sequence. In the embodiment illustrated there are five tanks, T1, T2, T3, T4 and T5. It will be understood that any number of tanks may be used, provided there are at least two. A valve arrangement 6 controls flow of solution from each tank to the processing unit 2. A pump 4 is provided between the tanks and the processing unit.

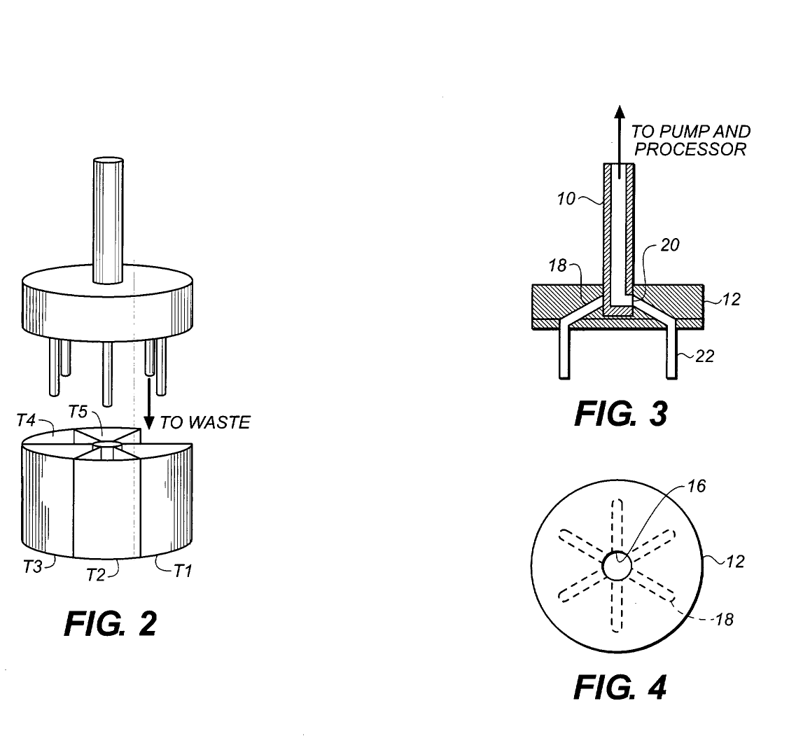

FIGS. 2, 3 and 4 illustrate part of the arrangement shown schematically in FIG. 1.

In the embodiment shown the series of storage tanks T1, T2, T3, T4 and T5 are formed in a circular configuration. The valve arrangement 6 is in the form of a hollow tube 10 connected to the pump 4 and thus to the processing unit 2. The hollow tube fits into a circular hole 16 in the centre of a disc member 12 which is located above the circular configuration of tanks. The tube 10 fits water-tightly into the hole 16 allowing rotation of the tube within the hole. At the lower end of the tube, i.e. the end fitted within the disc member 12, there is provided a hole 20 in the wall of the tube. The disc member 12 is provided with a number of channels 18. Each channel 18 leads to a tank via a pipe 22. In the arrangement illustrated in FIGS. 2, 3 and 4 the outlet of each channel 18 is positioned above a respective tank. The other end of each channel may be in connection with the hole 20, dependent on the rotational position of the hollow tube 10.

The wash solution contained within the supply unit 8 is used to clean both the processed material which passes through the processing unit or station 2 and the processing unit itself. The parts of the unit 2 which are contaminated with processing solution may be cleaned either while the processed material is contained within the unit 2 or after the material has passed out of the unit 2. At least two volumes of wash solution are used in sequence.

In operation a first volume of solution is supplied to the processing unit from a first tank T1. After use this volume of solution is discarded to waste. A second volume of solution is supplied to the processing unit from tank T2. After use this volume of solution is transferred to tank T1. Optionally, a third volume of solution is supplied to the processing unit from tank T3. After use this volume of solution is transferred to tank T2. The figures show an embodiment with five tanks. In all cases the wash solution is transferred from one tank to the processing unit, used for cleaning and then transferred to the previous tank in the sequence. The only exception is the first volume of wash solution supplied from the first tank. In this case the wash solution is discarded after use.

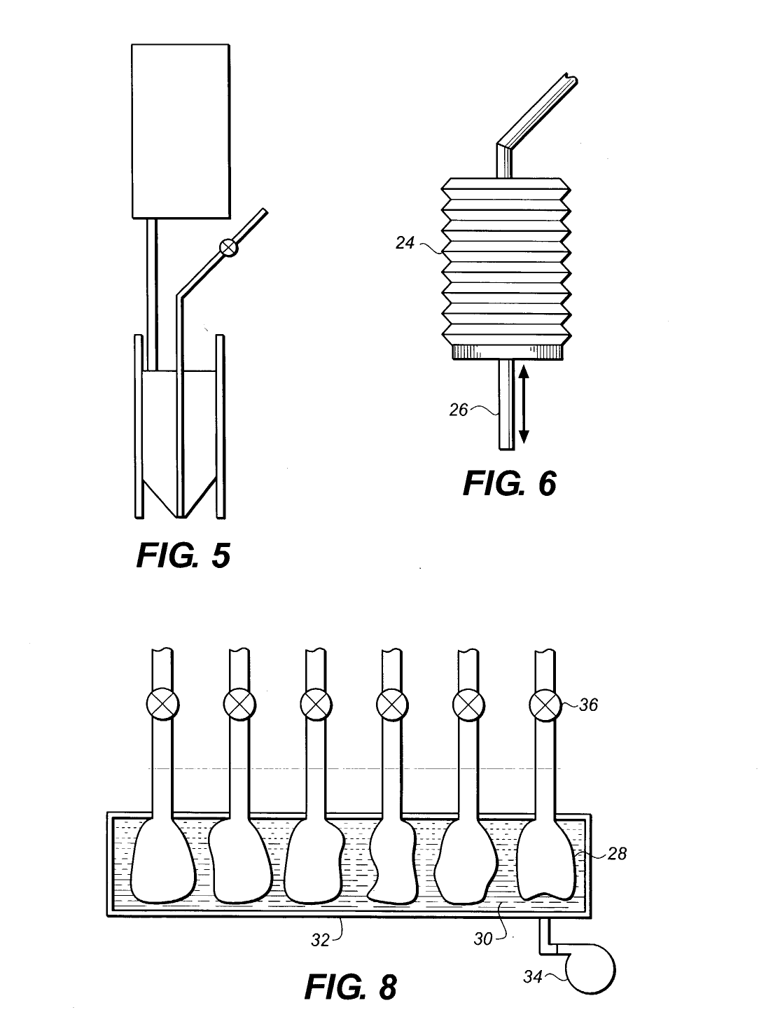

The last tank containing fresh wash solution is supplied from a reservoir. This could be supplied, for example, using an automatic topping up system using a “chicken feeder” arrangement. A typical chicken feeder arrangement is illustrated in FIG. 5. These are well known arrangements and will not be described further.

A single pump can be employed in conjunction with an arrangement of valves to control the flow of wash solution to and from the tanks and to waste.

In the embodiment shown in FIGS. 2, 3 and 4 the hollow tube 10 is rotated such that the hole 20 is aligned with a channel 18 to supply wash solution to the processing unit 2 from the tank associated with that channel. After use the tube is then rotated to align the hole 20 with the channel 18 associated with the previous tank to transfer the used wash solution to that previous tank. The rotation of the tube is controlled by any suitable means.

The volumes of the storage tanks need only to be sufficient to supply enough solution for the purpose of washing the material and equipment. If for example, the area of processed material was 0.1 m² and the replenishment rate of the wash solution was 200 ml/m² the volume of solution needed to wash the material would be 20 ml. An additional volume would be needed for the equipment surfaces, say another 20 ml. The tank volume could be as little as 50 ml.

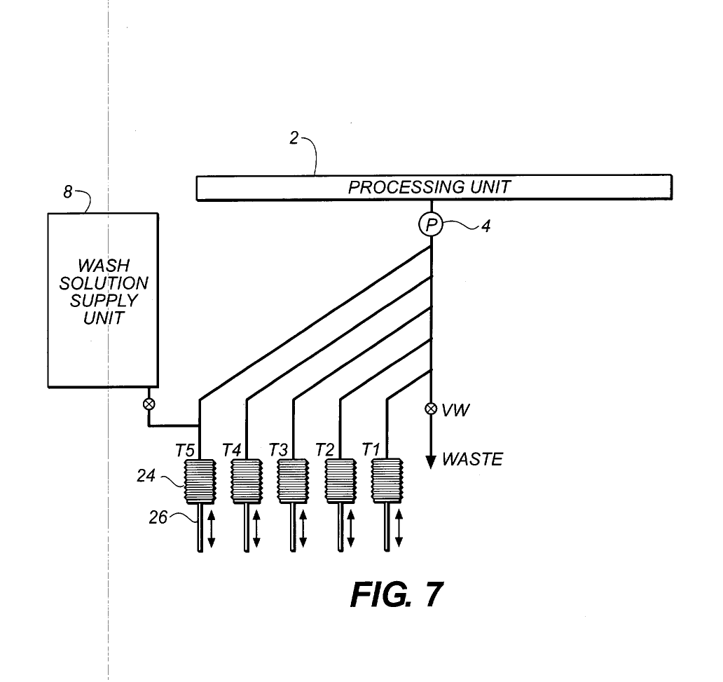

As an alternative to the arrangement of valves shown in the earlier figures each of the tanks could be made with flexible or elastic walls. For example, the tank could be in the form of a bellows and the bellows could be compressed and expanded by some means, for example as in a bellows pump. Such an alternative is illustrated in FIG. 6. The bellows tank 25 is compressed and expanded by means of an actuator 26. Many actuators are known in the prior art and it is not an essential feature of the invention that any particular type is used. FIG. 7 illustrates an embodiment of the invention employing the tanks illustrated in FIG. 6. This embodiment is similar to that shown in FIG. 1. However the embodiment of FIG. 7 does not require the valve arrangement 6. Instead, flow of solution from each tank to the processing unit 2 is controlled by the action of the bellows tanks 24. The action of compressing and expanding the bellows is used to force liquid in and out of the processor unit being washed. If the tanks were made of elastic material such as rubber, they could be compressed and expanded directly.

Alternatively a single pump could both pump and remove liquid from a sealed volume surrounding a flexible tank and, by displacement, alter the tank volumes. This arrangement is illustrated in FIG. 8. A sealed container 32 contains a liquid 30 and a number of flexible tanks 28. A pump 34 controls the volume of liquid 30 in the container 32. Valves 36 determine which flexible tank 28 is emptied by the change in volume of liquid 30. Either a single pumped volume and an arrangement of valves controlling the flow in and out of each tank would be needed, as shown, or the displacing liquid could be supplied to a set of sealed units surrounding each flexible tank via a set of valves which directs the pumped displacing liquid into the volume round the appropriate flexible tank.

It has been already noted that bio-growth in conventional deep-tank systems needs to be controlled by growth inhibitors such as biocides. These are not good for the environment and can raise health and safety issues. The use of small amounts of liquid to perform a wash step combined with small storage tanks can lead to dramatic reductions in tank residence times. In continuous use, for example, in systems where the tank volume equals the wash solution volume corresponding to the usage rate per unit area, the residence time in the tank is essentially the same as the time between washing operations. It may be possible to avoid the use of at least the majority of the biocide by emptying the tanks and refilling them with fresh solutions when the equipment is not used without excessive wastage of wash solutions if the tank volumes are very low.

Conventional deep-tank systems could be converted to enable the use of very low operating volumes by using sprays of washing liquid in place of immersion in the full tank. This would provide very effective washing and could use existing re-circulation/agitation pumps to provide the spray pressure. Combined with an off-line counter-current system according to this invention, an existing machine could be converted to provide the advantages of low residence time with the consequent reduction in bio-growth.

It will be appreciated that the invention is not limited to single use processes. The invention could also be used after a replenished tank series where the material to be washed is treated at least twice with wash solution in the same station. Typically, four tanks are used for washing and more tanks allow reductions in wash solution volumes and consequent effluent volumes. The equipment cost savings realized by using a single station several times need not be offset by greatly increased effluent volumes as would be the case if the invention was not used and several applications of fresh water or wash solution were used. The invention can be used in either batch mode or continuous mode. The invention can be used with either film or paper, color or black and white.

It will be further appreciated that the invention is not limited to photographic materials and processing equipment but can be applied to any cleaning process where repeated use of volumes of liquid is needed to achieve the required degree of cleanliness. For example the invention could be used in washing machines for clothes in which several rinsing steps are required. The amount of rinsing water required would be reduced by using the method of the invention.

Parts List

2 processing station

4 pump

6 valve arrangement

8 wash solution supply unit

10 tube

12 disc member

16 hole

18 channel

20 hole

22 pipe

24 bellows tank

26 actuator

28 flexible tank

30 liquid

32 container

34 pump

36 valve

What is claimed is:

1. A method of washing a processing station and/or processed material located therein wherein wash solution is stored in and supplied from at least two tanks, one tank of which is supplied with a source of clean wash solution, the method comprising the steps of supplying a first volume of wash solution to the station and, after use, discarding said solution to waste, supplying at least a second volume of wash solution to the station and, after use, transferring said solution to the tank from which the previous volume of wash solution was supplied, the last volume of wash solution used being taken from the tank supplied with the source of clean wash solution.

2. A method as claimed in claim 1 wherein the volume of solution supplied from each tank has a maximum of ten liters.

3. A method as claimed in claim 1 wherein the processing station is used for photographic processing.

4. A method as claimed in claim 1 wherein the wash solution is water.

5. A method as claimed in claim 3 wherein the wash solution is stabilizer solution.

6. A method as claimed in claim 3 wherein the solution discarded to waste is used for replenisher solution.

7. A method as claimed in claim 1 wherein the wash solution contains anti-bacterial components.

8. A method as claimed in claim 1 wherein the processing station is used for both chemical development and washing.

9. A method as claimed in claim 3 wherein the material is paper.

10. A method as claimed in claim 3 wherein the material is film.

11. An arrangement for washing a processing station and/or processed material located therein, comprising at least two supply tanks in which wash solution is stored and supplied from, one tank being in fluid connection with a supply of clean wash solution, the at least two tanks being connected to the processing station such that volumes of solution within each tank are used in sequence, each volume of solution passing from one tank to the processing station and then, after use, transferred to the tank from which the previous volume of solution was supplied, the tank in connection with the supply of clean wash solution being the last to supply a volume of wash solution to the station.

12. An arrangement as claimed in claim 11 wherein the supply tanks hold a volume of between 20 ml and 1000 ml per square meter of area to be washed.

13. An arrangement as claimed in claim 12 wherein the supply tanks hold a volume of between 50 ml and 500 ml per square meter of area to be washed.

14. An arrangement as claimed in claim 11 wherein the tank in connection with the supply of clean wash solution has an automatic top up system.

15. An arrangement as claimed in claim 11 wherein the flow of wash solution between the tanks and the station is controlled by a pump and valve means.

16. An arrangement as claimed in claim 15 wherein the valve means comprises a hollow rotatable tube member in variable fluid connection with the tanks.

17. An arrangement as claimed in claim 11 wherein the tanks have flexible walls and the arrangement includes means to compress and expand the volumes of the tanks.

18. An arrangement as claimed in claim 17 wherein the means comprises a bellows pump.

19. An arrangement as claimed in claim 17 wherein the flexible tanks are located within a sealed container full of solution and the means comprises a pump to displace the solution and thus alter the tank volumes.

20. A method of processing a material in which each step of the process takes place in a different process station, at least one of the stations being equipped with an arrangement as claimed in claim 11.

21. A method of processing a material in which the whole process takes place in a single process station, the station being equipped with an arrangement as claimed in claim 11.

22. A method of processing a material in which each process takes place in a different process station, at least one of the stations being washed by a method as claimed in claim 1.

23. A method of processing a material in which the whole process takes place in a single process station, the station being washed by a method as claimed in claim 1.
